(19) United States
(12) Patent Application Publication
(10) Pub. No.: US 2007/0228339 A1
(43) Pub. Date: Oct. 4, 2007

(54) Low electric conductivity high heat radiation polymeric composition and molded body

(75) Inventors: Hideyuki Fujiwara, Nishikasugai-gun (JP); Yoshiki Nakamura, Nishikasugai-gun (JP); Satoshi Komiyama, Minato-ku (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-Ken (JP); TOKAI CARBON CO., LTD., Tokyo (JP)

(21) Appl. No.: 11/730,016

(22) Filed: Mar. 29, 2007

(30) Foreign Application Priority Data
Mar. 31, 2006 (JP) 2006-099139
Mar. 6, 2007 (JP) 2007-056465

(51) Int. Cl. H01B 1/24

(52) U.S. Cl. 252/511

(57) ABSTRACT

The present invention provides a low electric conductivity, high heat radiation polymeric composition which includes a polymeric material and a carbon-based filler compounded with the polymeric material, wherein the carbon-based filler has an electron withdrawing agent grafted onto a surface of the carbon-based filler.

### INCORPORATION BY REFERENCE

The present application claims priority under 35 U.S.C. § 119 to Japanese Patent Application Nos. 2006-099139 filed on Mar. 31, 2006 and 2007-056465 filed on Mar. 6, 2007. The contents of these applications are incorporated herein by reference in their entireties.

### TECHNICAL FIELD

The present invention relates to a polymeric composition and a molded body having low electric conductivity and high heat radiation.

### BACKGROUND OF THE INVENTION

In consideration of environmental issues such as CO₂ reduction, advances are being made in reducing the fuel consumption of automobiles, and in recent years, hybrid vehicles have gained much attention. The spread of fuel cell vehicles and so on is also foreseen in the future. With respect to components related to batteries and motors, many products require low electric conductivity and high heat radiation, and various materials and shapes have been studied with a view to securing both of these characteristics.

However, it is difficult to secure both of these characteristics in a single material for practical use. The reason for this is that high thermal conductivity (which means thermal conductivity is high) is a prerequisite of high heat radiation, but almost all materials in practical use that possess high thermal conductivity also possess high electric conductivity. This will now be described more specifically.

(1) Metals possess both high thermal conductivity and high heat radiation, but also possess high electric conductivity, and therefore without modification, low electric conductivity (preferably electric insulation) cannot be secured. Accordingly, an insulating plate made of resin or the like must be provided separately, leading to problems regarding the low heat radiation of the insulating plate and the weight of the product, which increases in proportion to the weight of the insulating plate. Moreover, the specific gravity of the metal itself is high.
(2) Polymeric materials (resin, rubber) possess low electric conductivity (essentially electric insulation), but also possess low thermal conductivity, and therefore without modification, high heat radiation cannot be secured. Accordingly, the shape of the product must be manipulated (by creating air-transmitting passages) to secure high heat radiation, leading to an increase in the size of the product and a corresponding increase in the required disposal space.

### (3) To solve these problems, the following composite materials have been studied.

Japanese Patent Application Publication No. JP-A-2002-146154 describes a material obtained by compounding a styrene-based thermoplastic elastomer/PP with a fine ceramic.

Japanese Patent Application Publication No. JP-A-2002-88249 describes a material obtained by compounding a polymeric material with a graphitized hydrocarbon containing a boron compound.

Japanese Patent Application Publication No. JP-A-2002-3717 describes a material obtained by compounding silicone rubber with a graphitized carbon fiber and an electrical insulating thermally conductive filler.

Japanese Patent Application Publication No. JP-A-H7-111300 describes a material obtained by compounding silicone rubber with boron nitride.

Japanese Patent Application Publication No. JP-A-H3-79665 describes a material obtained by compounding a polyamide resin with magnesium oxide and carbon black.

### SUMMARY OF THE INVENTION

JP-A-2002-146154, JP-A-2002-88249, JP-A-2002-3717, JP-A-H7-111300, and JP-A-H3-79665 all describe composite materials in which an attempt is made to secure both low electric conductivity and high heat radiation by filling a filler constituted by a ceramic or the like for achieving high heat radiation into a polymeric material (base material) for achieving low electric conductivity. However, the following problems arise in these composite materials.

(a) High heat radiation cannot be secured unless a considerably large amount of filler is filled (unless the filler is filled at a high density).
(b) When a large amount of filler is filled, the specific gravity of the material increases, causing the product to increase in weight.
(c) The compatibility between the filler and the polymeric material may be poor, leading to a reduction in the reinforcing property and fragility as a material.
(d) Depending on the type of filler, gas may be generated such that the polymeric material is adversely affected thereby.

It is an object of the present invention to solve the problems described above by providing a polymeric composition and a molded body capable of securing all of low electric conductivity, high heat radiation, and low specific gravity.

[A] A low electric conductivity, high heat radiation polymeric composition of the present invention comprises a polymeric material and a carbon-based filler compounded with the polymeric material, wherein the carbon-based filler has an electron withdrawing agent grafted onto a surface of the carbon-based filler.

Aspects of each element of the present invention will be illustrated below using examples.

### [1] Polymeric Material

There are no particular limitations on the polymeric material, but resin, rubber, and a thermoplastic elastomer may be mentioned as examples.

### 1. Resin: an olefin-based resin such as PP or PE, PPS (polyphenylene sulfide), LCP (liquid crystal polymer), PBT (polybutylene terephthalate), or an engineering plastic resin such as POM (polyacetal) may be mentioned as examples.

### 2. Rubber: EPDM (ethylene propylene diene copolymer), CR (chloroprene rubber), NBR (butadiene-acrylonitrile rubber), Q (silicone rubber), and the like may be mentioned as examples.

3. Thermoplastic elastomer: olefin-based, styrene-based, vinyl chloride-based, polyester-based, polyurethane-based, polyamide-based, and fluorine-based thermoplastic elastomers may be mentioned as examples.

### [2] Carbon-Based Filler Having Electron Withdrawing Agent Grafted onto Surface Thereof

### [2-1] Carbon-Based Filler

There are no particular limitations on the carbon-based filler, but carbon black (fine-grain carbon), carbon fiber, petroleum coke, graphite, carbon nanotubes, and so on may be mentioned as examples.

### [2-2] Electron Withdrawing Agent

There are no particular limitations on the electron withdrawing agent, but compounds containing an ether group, an epoxy group, an acyl group, a carbonyl group, an amide group, or a siloxane bond may be mentioned as examples. Preferable examples include an electron withdrawing agent carrying an ether group, an epoxy group, an acyl group, a carbonyl group, an amide group, or a siloxane bond in a grafted polymer and carrying diol at one terminal, such as poly(2-ethyl hexyl acrylate) or poly(octyl acrylate).

### [2-3] Graft Ratio of Electron Withdrawing Agent

There are no particular limitations on the graft ratio of the electron withdrawing agent, but 0.5% by weight or more is preferable, 0.5 to 50% by weight is more preferable, and according to the filler types, the following ranges are further more preferable.

When the filler is carbon black, the graft ratio of the electron withdrawing agent is preferably 20% by weight or more, and more preferably from 20 to 50% by weight. When the graft ratio is less than 20% by weight, it may be impossible to obtain a sufficient electric resistance value.

When the filler is PAN (polyacrylonitrile) based carbon fiber, the graft ratio of the electron withdrawing agent is preferably 10% by weight or more, and more preferably from 10 to 50% by weight. When the graft ratio is less than 10% by weight, it may be impossible to obtain a sufficient electric resistance value.

When the filler is pitch-based carbon fiber, the graft ratio of the electron withdrawing agent is preferably 0.5% by weight or more, and more preferably from 0.5 to 10% by weight. When the graft ratio is less than 0.5% by weight, it may be impossible to obtain a sufficient electric resistance value.

### [2-4] Grafting Method of Electron Withdrawing Agent

There are no particular limitations on the method of grafting the electron withdrawing agent onto the surface of the carbon-based filler, and a known grafting technique may be used.

The following is an example of a grafting method.

### 1. Carbon black (FIG. 1A) is subjected to ozone oxidation (FIG. 1B), whereupon an isoparaffin-based hydrocarbon solvent is added to moisten the ozone-oxidized carbon black.

2. Next, a triisocyanate compound (triisocyanate hexamethylene isocyanate) and a modified polymer (propene 1, 2 diol poly(2-ethyl hexyl carbonyl ethene) sulfide having a diol at one terminal are added, whereupon the mixture is mixed and kneaded (FIGS. 1C, 1D).

### 3. Next, dibutyltindilaurate is added, and the mixture is kneaded.

### 4. Next, the resultant slurry is subjected to mechanical dispersion in a high-pressure homogenizer.

### 5. The dispersed slurry is reacted for six hours at 70° C. while being stirred.

6. Next, the isoparaffin-based solvent serving as a solvent is vaporized to obtain electron withdrawing agent-grafted carbon black 2 (FIG. 1E). Note that FIG. 1F shows the electron withdrawing agent-grafted carbon black 2 compounded with a polymeric material 1.

### [3] Compounding

### [3-1] Compounding Amount of Carbon-Based Filler

There are no particular limitations on the amount of carbon-based filler compounded with the polymeric material, but from 10 to 80% by volume is preferable, and from 20 to 50% by volume is more preferable. When the compounding amount is too small, it tends to be impossible to obtain a sufficient thermal conductivity path, and when the compounding amount is too large, the material characteristics tend to be damaged, and workability tends to lower.

### [4] Orientation of Carbon-Based Filler

The carbon-based filler compounded with the polymeric material may be used after being oriented by a magnetic field or the like. With this orientation, the thermal conductivity can be raised even when the compounding amount of the carbon-based filler remains the same, or when the same thermal conductivity is sufficient, the compounding amount of the carbon-based filler can be decreased. Orientation indicates a state in which carbon-based filler (mainly carbon fiber) having anisotropy in its shape is arranged regularly and in a specific direction within a polymeric material serving as a base material.

### [4-1] Confirmation and Evaluation of Orientation

The orientation can be confirmed using the following two methods and evaluated using Method 1 in particular, for example.

### 1. Azimuth intensity distribution measurement of crystal lattice of carbon-based filler using X-ray diffraction analysis

In carbon fiber, for example, graphite crystals are arranged regularly in a fiber direction, and by measuring the azimuth intensity distribution of the graphite crystal (0. 0. 2) surface through X-ray diffraction analysis (as in FIG. 5, to be described below, for example), the orientation direction of the carbon fiber can be learned. When the carbon fiber is oriented, a peak occurs in the azimuth intensity distribution. When the carbon fiber is particularly well oriented, the full width at half maximum (FWMH) is measured to define the degree of orientation as described below. When the degree of orientation is 0.7 or more, the orientation can be perceived visually, and the actions and effects of the orientation can be evaluated with clarity. A degree of orientation from 0.9 to 1 may be considered particularly favorable.

Degree of orientation=(180°−full width at half maximum)/180° <Formula 1>

### 2. Visual Confirmation Through Observation with Microscope etc.

A molded body is cut along a surface on which the orientation is to be confirmed, and the direction of the carbon-based filler is observed using a scanning electron microscope or the like. Note, however, that it is difficult to evaluate the degree of orientation quantitatively from this observation.

### [4-2] Orientation Direction

There are no particular limitations on the direction in which the carbon-based filler of the polymeric material is oriented, but when the molded body includes a plate-form portion, for example, the carbon-based filler may be oriented in either direction along the surface of the plate-form portion or in the thickness direction of the plate-form portion.

### [4-3] Orientation Method

There are no particular limitations on the method of orienting the carbon-based filler, but the following magnetic field method and processing method may be cited as examples.

### 1. Method Using Magnetic Field

In this method, a molded body or a molded body serving as a material of the molded body is molded using the low electric conductivity, high heat radiation polymeric composition described above, and the carbon-based filler in the polymeric material of the molded body is oriented using a magnetic field when the polymeric material is in a molten state. The carbon-based filler is oriented in the direction of the magnetic field (the direction of the line of magnetic force). Following orientation, the polymeric material is cooled and hardened. There are no particular limitations on the intensity of the magnetic field, but a strong magnetic field of at least 1 T (tesla) is preferable. According to this method, various orientation directions including the orientation direction described above as an example can be realized simply by aligning the orientation direction with the direction of the magnetic field.

### 2. Processing Method

In this method, a molded body or a molded body serving as a material of the molded body is molded using the low electric conductivity, high heat radiation polymeric composition described above, and the carbon-based filler in the polymeric material of the molded body is oriented by deforming at least a part of the molded body in an elongated manner through processing performed when the polymeric material is in a molten state. Thus, the carbon-based filler is oriented in the elongation direction. Following orientation, the polymeric material is cooled and hardened.

Note that in the methods described above, a molded body serving as a material of the molded body denotes a precursory molded body in a case where a plurality of molding stages is performed, for example a sheet member in a case where a molded body is molded into a three-dimensional shape by subjecting sheet members to vacuum molding or the like.

### [B] A low electric conductivity, high heat radiation molded body of the present invention is molded using the low electric conductivity, high heat radiation polymeric composition described above.

There are no particular limitations on the specific products formed by the molded body, but the following products may be mentioned as examples.

(a) An insulating plate 12 or a battery case 13, for insulating battery elements in a battery pack 11 of an electrically driven vehicle such as a hybrid vehicle or a fuel cell vehicle, as shown in FIG. 2, or a bus bar module, or the like.

(b) A motor coil insulator/sealing material or the like for the motor of an electrically driven vehicle or the like.

(c) An inverter case for an electrically driven vehicle, a household appliance, or the like.

(d) A radiation sheet, a casing, or the like for a household appliance, personal computer, or the like.

The developmental background and actions of the present invention are as follows.

A carbon-based filler has high thermal conductivity (and therefore high heat radiation), and has a reinforcing property in relation to polymeric material, and is therefore suitable for the present invention. However, a carbon-based filler also has high electric conductivity, and therefore an object of the present invention was to suppress this electric conductivity.

As a result of various investigations, it was found that by grafting an electron withdrawing agent onto the surface of the carbon-based filler, electron movement on the surface could be suppressed, and thus a carbon-based filler with reduced electric conductivity was developed. By compounding a polymeric material with this carbon-based filler, a novel composition possessing low electric conductivity, high heat radiation, and good strength was obtained.

According to the polymeric composition and molded body of the present invention, low electric conductivity, high heat radiation, good strength, and low specific gravity can all be secured.

### BRIEF DESCRIPTION OF THE DRAWINGS

FIG. 1 is a view illustrating an electron withdrawing agent-grafted carbon-based filler, and a polymeric composition compounded with the electron withdrawing agent-grafted carbon-based filler, according to the present invention;

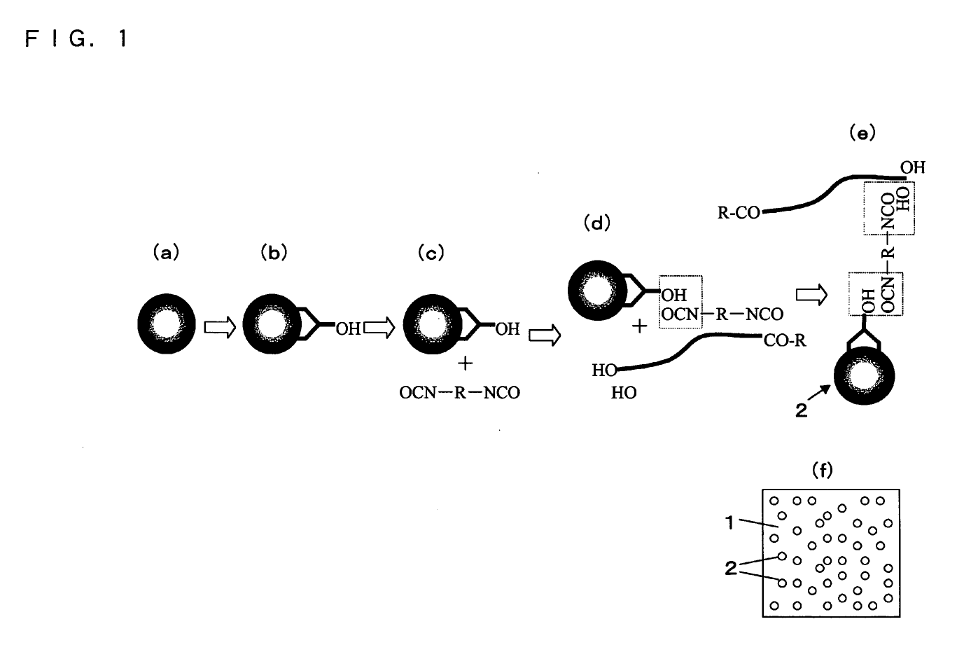

FIG. 2 is a perspective view showing an example of a molded body molded using the polymeric composition of the present invention.

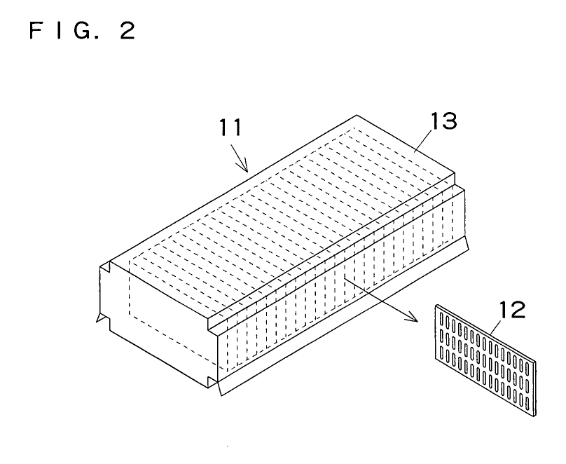

FIG. 3 is a view illustrating a device and a method for orienting carbon fibers using a magnetic field;

FIG. 4 is a view also illustrating the method for orienting carbon fibers using the magnetic field;

FIG. 5 is a graph showing the measurement results of the azimuth intensity distribution using an X-ray diffraction analysis;

FIG. 6 is a microphotograph of an example of a molded body in which carbon fibers were not oriented; and

FIG. 7 is a microphotograph of an example of a molded body in which carbon fibers were oriented.

### DETAILED DESCRIPTION OF THE INVENTION

The present invention is a polymeric composition having low electric conductivity and high heat radiation which comprises a polymeric material and a carbon-based filler of from 10 to 80% by volume compounded with the polymeric material, wherein the carbon-based filler has an electron withdrawing agent grafted onto a surface of the carbon-based filler at a graft ratio of 0.5% by weight or more. The present invention is also a molded body having low electric conductivity and high heat radiation using this low electric conductivity, high heat radiation polymeric composition.

### EXAMPLES

A polyethylene (PE) resin (manufactured by Sumitomo Chemical Co., Ltd., product name “Sumikasen G807”) was used as the base polymeric material, and each filler shown in Table 1 to Table 5 below was compounded therein in predetermined compounding amounts. The following Table 1 shows the filler types used in examples 1 to 10, the polymer type of the electron withdrawing agent used to graft each filler, and the graft ratio. Here, the graft ratio was determined by a heating loss measurement method. More specifically, the grafted carbon-based filler was heated from 110° C. to 1000° C. in an inert gas (Ar gas), and the graft ratio was obtained by converting the weight loss ratio thereof into the weight gain ratio of the carbon fiber. This is based on the concept that under these conditions, the carbon-based filler does not lose weight, and only the grafted polymer vaporizes to lose weight.

TABLE 1

| | Graft Polymer Type | Graft Ratio |
|---|---|---|
| Filler Type of Examples | of Examples | (% by weight) |
| Carbon black | Dimethyl polysiloxane | 30 |
| PAN-based carbon fiber 1 | Silicone-based polymer | 23.3 |
| PAN-based carbon fiber 2 | Silicone-based polymer | 24.2 |
| PAN-based carbon fiber 3 | Silicone-based polymer | 24.4 |
| PAN-based carbon fiber 4 | Carbodiimide-based | 26.4 |
| | polymer | |
| PAN-based carbon fiber 5 | Silicone-based polymer | 34.6 |
| PAN-based carbon fiber 6 | Carbodiimide-based | 22 |
| | polymer | |
| Pitch-based carbon fiber 1 | Epoxy-based polymer | 0.7 |
| Pitch-based carbon fiber 2 | Epoxy-based polymer | 1.5 |

TABLE 2

| | | | | | Comparative | Comparative | Comparative |
|---|---|---|---|---|---|---|---|
| Composition/Evaluation item | | | Example 1 | Example 2 | Example 1 | Example 2 | Example 3 |
| Composition | Polyethylene resin | | 75 | 60 | 100 | 75 | 60 |
| (% by volume) | Filler | Electron withdrawing | 25 | 40 | — | — | — |
| | type | agent-grafted carbon | | | | | |
| | | black | | | | | |
| | | None | — | — | 0 | — | — |
| | | Carbon black (no graft) | — | — | — | 25 | 40 |

| | | | | | |
|---|---|---|---|---|---|
| Thermal conductivity (W/mk) | 1.1 | 1.4 | 0.3 | 1.1 | 1.5 |
| Volume specific resistance (Ω · cm) | 3.2 × 10⁵ | 8.7 × 10⁴ | 1.0 × 10¹³ | 2.7 × 10⁰ | 6.0 × 10⁻¹ |
| | | | or more | | |
| Specific gravity (g/cc) | 1.14 | 1.27 | 0.92 | 1.14 | 1.27 |

TABLE 3

| | | | Comparative | Comparative | Comparative | Comparative | Comparative |
|---|---|---|---|---|---|---|---|
| Composition/Evaluation item | | | Example 4 | Example 5 | Example 6 | Example 7 | Example 8 |
| Composition | Polyethylene resin | | 75 | 75 | 60 | 75 | 60 |
| (% by volume) | Filler | Pitch-based carbon fiber | 25 | — | — | — | — |
| | type | (no graft) | | | | | |
| | | Graphite (no graft) | — | 25 | 40 | — | — |
| | | Boron nitride (no graft) | — | — | — | 25 | 40 |

| | | | | | |
|---|---|---|---|---|---|
| Thermal conductivity (W/mk) | 1.1 | 1.0 | 1.9 | 0.7 | 1.2 |
| Volume specific resistance (Ω · cm) | 5.5 × 10¹ | 3.3 × 10² | 1.5 × 10¹ | 1.0 × 10¹³ | 1.0 × 10¹³ |
| | | | | or more | or more |
| Specific gravity (g/cc) | 1.24 | 1.24 | 1.43 | 1.26 | 1.46 |

In examples 1 and 2, carbon black grafted with the electron withdrawing agent of Table 1 is used as a filler. As shown in Tables 2 and 3, these examples were compared with comparative examples 1 to 8 using various filler types not grafted with an electron withdrawing agent.

The Filler of examples 1 and 2 was obtained by grafting (at a graft ratio of 30%) modified dimethyl polysiloxane (diol at one terminal) (manufactured by Chisso Corporation, Silaplane FM-DA21), which serves as an electron withdrawing agent, onto the surface of carbon black manufactured by Tokai Carbon Co., Ltd. under the product name “Seast 116”.

The carbon black of comparative examples 2 and 3 is the aforementioned carbon black manufactured by Tokai Carbon Co., Ltd. under the product name “Seast 116”.

Carbon fiber of the comparative example 4 is carbon fiber manufactured by Mitsubishi Chemical Functional Products, Inc. under the product name “Dialead K223HG”.

Graphite of comparative examples 5 and 6 is graphite manufactured by Oriental Industry Co., Ltd. under the product name “OS Carbon Powder AT-No. 40S”.

Boron nitride used of comparative examples 7 and 8 is boron nitride manufactured by Denki Kagaku Kogyo Kabushiki Kaisha under the product name “Denka Boron Nitride HGP”.

TABLE 4

| | | | Comparative | | | | | | |
|---|---|---|---|---|---|---|---|---|---|
| Composition/Evaluation item | | | Example 9 | Example 3 | Example 4 | Example 5 | Example 6 | Example 7 | Example 8 |
| Composition | Polyethylene resin | | 75 | 75 | 75 | 75 | 75 | 75 | 75 |
| (% by volume) | Filler | PAN-based carbon fiber 1 | — | 25 | — | — | — | — | — |
| | type | PAN-based carbon fiber 2 | — | — | 25 | — | — | — | — |
| | | PAN-based carbon fiber 3 | — | — | — | 25 | — | — | — |
| | | PAN-based carbon fiber 4 | — | — | — | — | 25 | — | — |
| | | PAN-based carbon fiber 5 | — | — | — | — | — | 25 | — |
| | | PAN-based carbon fiber 6 | — | — | — | — | — | — | 25 |
| | | PAN-based carbon fiber | 25 | — | — | — | — | — | — |
| | | (no graft) | | | | | | | |

| | | | | | | | |
|---|---|---|---|---|---|---|---|
| Thermal conductivity (W/mk) | 0.5 | 0.3 | 0.4 | 0.4 | 0.4 | 0.4 | 0.4 |
| Volume specific resistance (Ω · cm) | 1.0 × 10⁵ | 2.0 × 10¹⁰ | 3.0 × 10⁹ | 1.0 × 10¹⁴ | 7.0 × 10⁷ | 3.0 × 10¹¹ | 1.0 × 10¹¹ |

In examples 3 to 8, PAN (polyacrylonitrile) based carbon fiber grafted with the electron withdrawing agent of Table 1 is used as a filler. As shown in Table 4, these examples were compared with the comparative example 9 using PAN-based carbon fiber not grafted with an electron withdrawing agent.

The fillers (the PAN-based carbon fiber 1 to 6 in Table 1) of examples 3 to 8 were formed by grafting (graft ratio 22 to 34.6%) a silicone-based polymer (product name “Modified Silicone Oil KF-8003”, manufactured by Shin-Etsu Chemical Co., Ltd.) or a carbodiimide-based polymer (product name “Carbodilite”, manufactured by Nisshinbo Industries, Inc.) serving as an electron withdrawing agent onto the surface of PAN-based carbon fiber having the product name “Torayca MLD30”, manufactured by Toray Industries, Inc.

The PAN-based carbon fiber of the comparative example 9 is the aforementioned “Torayca MLD30”.

Typically, PAN-based carbon fiber uses PAN (polyacrylonitrile) fiber as a raw material, and is manufactured by subjecting the PAN fiber to calcination at from 1000° C. to 1500° C. in an inert gas followed by carbonization at from 2000° C. to 3000° C.

In PAN-based carbon fiber, the graphite crystals constituting the carbon fiber are small and disposed randomly, and therefore electricity and heat pass through the fiber easily in various directions. Furthermore, PAN-based carbon fiber contains a large number of crystal defects, and therefore the thermal conductivity is lower than that of pitch-based carbon fiber. The aforementioned “Torayca MLD30” has a thermal conductivity of less than 20 W/m×k (although the details of this are not clear).

Further, an electron withdrawing agent can be grafted onto the entire fiber surface of PAN-based carbon fiber easily, and therefore the graft ratio is higher than that of pitch-based carbon fiber.

TABLE 5

| | | | Comparative | | |
|---|---|---|---|---|---|
| Composition/Evaluation item | | | Example 10 | Example 9 | Example 10 |
| Composition | Polyethylene resin | | 75 | 75 | 75 |
| (% by volume) | Filler | Pitch-based carbon fiber 1 | — | 25 | — |
| | type | Pitch-based carbon fiber 2 | — | — | 25 |
| | | Pitch-based carbon fiber | 25 | — | — |
| | | (no graft) | | | |

| | | | |
|---|---|---|---|
| Thermal conductivity (W/mk) | 1.2 | 0.9 | 0.9 |
| Volume specific resistance (Ω · cm) | 4.3 × 10⁰ | 5.1 × 10⁶ | 2.0 × 10⁵ |

In examples 9 and 10, pitch-based carbon fiber grafted with the electron withdrawing agent of Table 1 is used as a filler. As shown in Table 5, these examples were compared with the comparative example 10 using pitch-based carbon fiber not grafted with an electron withdrawing agent.

The filler of the example 9 (pitch-based carbon fiber 1 in Table 1) was formed by grafting (graft ratio 0.7%) an epoxy-based polymer (product name “EPICLON”, manufactured by Dainippon Ink and Chemicals, Inc.) serving as an electron withdrawing agent onto the surface of pitch-based carbon fiber having the product name “K223HGM”, manufactured by Mitsubishi Chemical Functional Products, Inc. (thermal conductivity 540 W/m·k).

The filler of the example 10 (pitch-based carbon fiber 2 in Table 1) was formed by grafting (graft ratio 1.5%) an epoxy-based polymer (product name “EPICLON”, manufactured by Dainippon Ink and Chemicals, Inc.) serving as an electron withdrawing agent onto the surface of pitch-based carbon fiber having the product name “K223QM”, manufactured by Mitsubishi Chemical Functional Products, Inc. (thermal conductivity 140 W/m·k).

The pitch-based carbon fiber of the comparative example 10 is pitch-based carbon fiber having the product name “K223HGM”, manufactured by Mitsubishi Chemical Functional Products, Inc.

Typically, pitch-based carbon fiber uses petroleum tar as a raw material, and is manufactured by compounding the tar with various compounding agents such as a thickening agent, forming strings at from 250 to 400° C., carbonizing the resulting substance at from 1000 to 1500° C. in an inert gas, and then baking the resulting substance at from 2500 to 3000° C. The difference in thermal conductivity between the pitch-based carbon fiber used in the example 9 and the example 10 is due to a difference in the final baking temperature. As the temperature increases, crystals are formed more favorably, leading to an increase in thermal conductivity. The graphite crystals in pitch-based carbon fiber are larger than those of PAN-based carbon fiber, arranged favorably in the fiber direction, and have fewer defects. Hence, electricity and heat pass through pitch-based carbon fiber easily in the fiber direction, and as a result, the thermal conductivity is far higher than that of PAN-based carbon fiber. Note that the thermal conductivity of the pitch-based carbon fiber increases greatly depending on the orientation, to be described below, and the reason for this is that when the fiber direction is aligned, the thermal conduction direction is also aligned.

Further, it is easy to graft an electron withdrawing agent onto the pitch-based carbon fiber at the end portion of the fiber length direction, but not easy to graft an electron withdrawing agent onto a midway point in the fiber length direction, and therefore, the graft ratio is lower than that of PAN-based carbon fiber.

### [Molding and Physical Properties Test]

The compounded materials of each example and comparative example were mixed by a Banbury mixer (model number “B-75”) of a Laboplastomill manufactured by Toyo Seiki Seisaku-Sho Ltd. under the following conditions: temperature 210° C., rotation speed 100 rpm, time 10 minutes, filling rate 70%. The mixed material was press-molded by a hand press device under the following conditions: pressure 20 MPa, temperature 210° C., time minutes, whereby a test piece measuring 25 mm×25 mm×(thickness) 2 mm was created.

The physical properties of each test piece were measured using the following method. The results are shown together in Table 2 to Table 5.

### (1) Thermal Conductivity Measurement

A measuring device with the product name of “Xe Flash Analyzer LFA447 Nanoflash”, manufactured by NETZSCH, was used, and measurement was performed at 25° C. (room temperature). The direction of the thermal conductivity corresponds to the thickness direction of the test piece.

### (2) Volume Specific Resistance Measurement

When the volume specific resistance was equal to or lower than 10⁶, a measuring device with the product name of “Loresta GP”, manufactured by Dia Instruments Co., Ltd. was used, and measurement was performed using a four-terminal method. Both the separation direction of the electric current application terminals (the electric current direction) and the separation direction of the potential taps (the potential difference direction) correspond to the thickness direction of the test piece. When the volume specific resistance was higher than 10⁶, a measuring device with the product name of “Hiresta UP”, manufactured by Dia Instruments Co., Ltd. was used, and measurement was performed using a double ring method (conforming to JISK6911).

### (3) Specific Gravity Measurement

A measuring device with the product name “SGM300P”, manufactured by Shimadzu Corporation, was used, and measurement was performed using an underwater substitution method. Note that this measurement was performed only in relation to examples 1 and 2, and comparative examples 1 to 8.

### [Evaluation of Physical Properties]

When evaluating the thermal conductivity and electric conductivity of the various compounded materials, the fact that the levels of the required high thermal conductivity and low electric conductivity differ according to the specific product type of the low electric conductivity, high heat radiation molded body molded using the compounded materials must be taken into account.

### (A) Evaluation of Examples 1 and 2 using Carbon Black

In examples 1 and 2, carbon black, which is a filler exhibiting a comparatively powerful action for raising the thermal conductivity and electric conductivity, is used, and the compounded materials are suitable for a molded body product (target) having a comparatively strong high heat radiation requirement and a comparatively weak low electric conductivity requirement.

As shown by the measurement results in Table 2 and Table 3, in the comparative example 1, the electric conductivity is low with respect to the requirement of the present invention, but the thermal conductivity is extremely low, which is completely unsuitable for the object of the present invention. In comparative examples 2, 3, 4, 5 and 6, the thermal conductivity is high with respect to the requirement of the present invention, but the electric conductivity is also high with respect to the requirement of the present invention, which is also unsuitable for the object of the present invention. In the comparative example 7, the electric conductivity is low with respect to the requirement of the present invention, but the thermal conductivity is not sufficiently high. The comparative example 8 is favorable in that the thermal conductivity is high and the electric conductivity is low, but when the amount of compounded ceramic filler is high, the specific gravity increases, which is the characteristic of ceramic filler. Furthermore, as noted above, ceramic filler is not compatible with resin, leading to a reduction in the reinforcing property and an increase in fragility.

In contrast, in examples 1 and 2, the thermal conductivity is sufficiently high with respect to the requirement of the present invention, and the electric conductivity is sufficiently low with respect to the requirement of the present invention, which is suitable for the object of the present invention. Furthermore, even when the amount of compounded filler is high, the specific gravity does not increase greatly. Moreover, the filler is highly compatible with resin, and therefore the reinforcing property is favorable and the resultant material is tough.

### (B) Evaluation of examples 3 to 8 using PAN-Based Carbon Fiber

In examples 3 to 8, PAN-based carbon fiber, which is a filler exhibiting a comparatively weak action for raising the thermal conductivity and electric conductivity, is used, and the compounded materials are suitable for a molded body product (target) having a comparatively weak high heat radiation requirement and a comparatively strong low electric conductivity requirement.

As shown by the measurement results in Table 4, the comparative example 9 is favorable in that the thermal conductivity is high with respect to the requirement of the present invention, but the electric conductivity is high with respect to the requirement of the present invention, which is unsuitable for the object of the present invention.

In contrast, in examples 3 to 8, the thermal conductivity is sufficiently high with respect to the requirement of the present invention, and the electric conductivity is sufficiently low with respect to the requirement of the present invention, which is suitable for the object of the present invention.

### (C) Evaluation of Examples 9 and 10 using Pitch-Based Carbon Fiber

In examples 9 and 10, pitch-based carbon fiber, which is a filler exhibiting a comparatively strong action for raising the thermal conductivity and electric conductivity, is used, and the compounded materials are suitable for a molded body product (target) having a comparatively strong high heat radiation requirement and a comparatively weak low electric conductivity requirement.

As shown by the measurement results in Table 5, the comparative example 10 is favorable in that the thermal conductivity is high with respect to the requirement of the present invention, but the electric conductivity is extremely high, which is completely unsuitable for the object of the present invention.

In contrast, in examples 9 and 10, the thermal conductivity is sufficiently high with respect to the requirement of the present invention, and the electric conductivity is sufficiently low with respect to the requirement of the present invention, which is suitable for the object of the present invention.

### [Preliminary Test for Orienting Carbon Fiber]

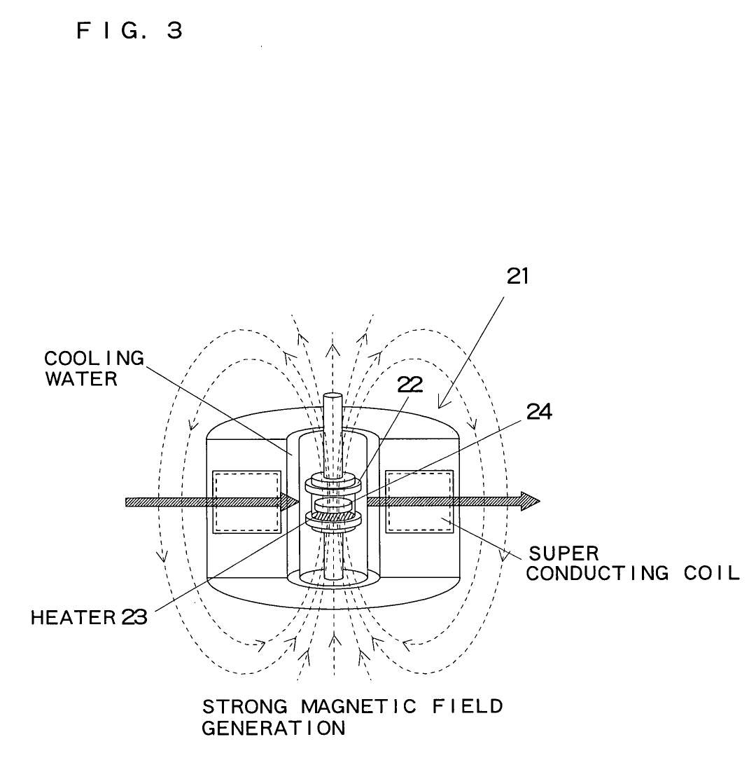

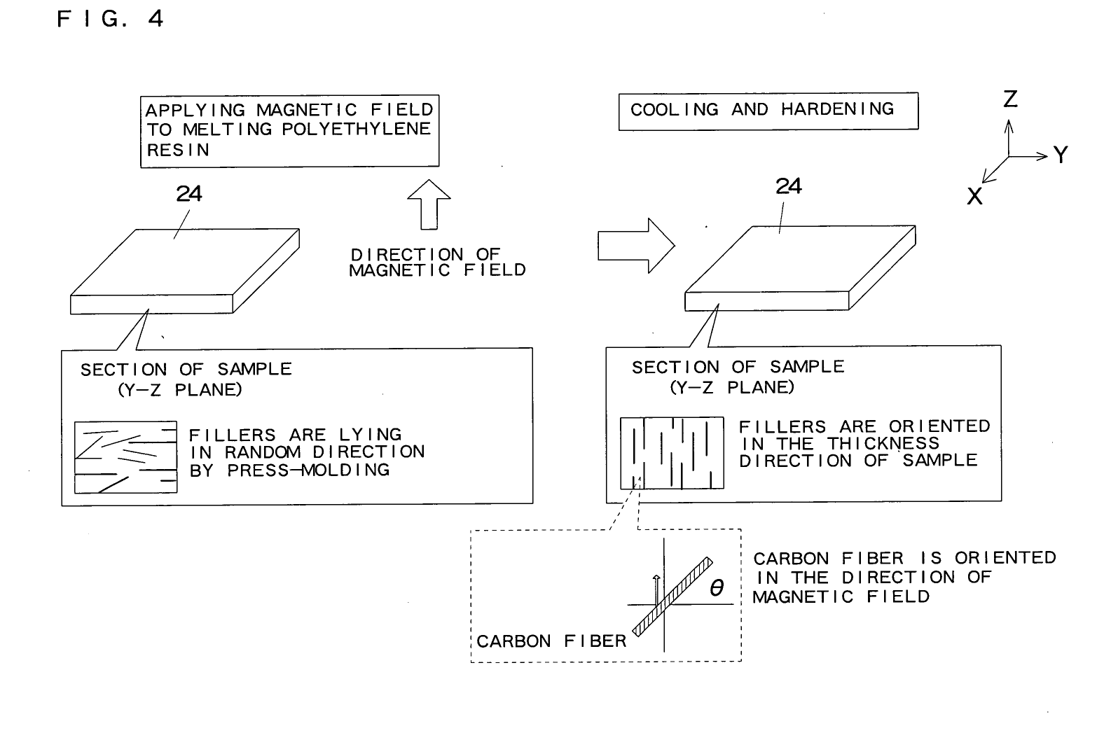

First, a preliminary test was performed to confirm the possibility of orienting the carbon fiber using a magnetic field. Four types of material obtained by compounding polyethylene resin with 15% by volume, 30% by volume, 25% by volume, and 35% by volume of pitch-based carbon fiber (no graft) were mixed under similar conditions to those described above and molded into test pieces of 25 mm×25 mm×2 mm, whereupon a magnetic field was applied to the 15% by volume compound example, the 25% by volume compound example, and the 35% by volume compound example (a magnetic field was not applied to the 30% by volume compound example, and in another case, a magnetic field was not applied to the 25% by volume compound example). More specifically, orientation was performed using the following devices and procedures, as shown in FIGS. 3 and 4.

### (1) A cooling type superconducting magnet device (HF10-100 VHT), manufactured by Sumitomo Heavy Industries, Ltd., was used as a magnetic field generating unit.

(2) An electric heater 23 was disposed in the lower portion of a space 22 (bore) positioned in a central magnetic field portion of this device 21, and test pieces 24 described above were set on the electric heater 23 one by one such that the test piece thickness direction corresponded to the magnetic field direction (the direction of the magnetic force line).
(3) The test piece 24 was heated in the space by the electric heater 23 to a temperature region (during implementation, 220° C.) for melting polyethylene resin, and the polyethylene resin serving as the base material of the test piece was melted. At this time, the test piece was held so as to maintain the dimensions described above.

### (4) The device was activated while maintaining the heating and temperature described above to apply a magnetic field (during implementation, 8 T (tesla)) to the test piece, and the test piece 24 was left within the magnetic field for one hour.

### (5) Heating was then halted, and the test piece 24 was left for 0.5 hours to cool naturally so that the polyethylene resin base material of the test piece hardened.

### (6) The test piece 24 was extracted from the space 22 in the device 21 and the orientation of the carbon fiber was confirmed.

The orientation of the carbon fiber was confirmed using the following two methods.

### 1. Azimuth Intensity Distribution Measurement of Crystal Lattice of Filler using X-Ray Diffraction Analysis

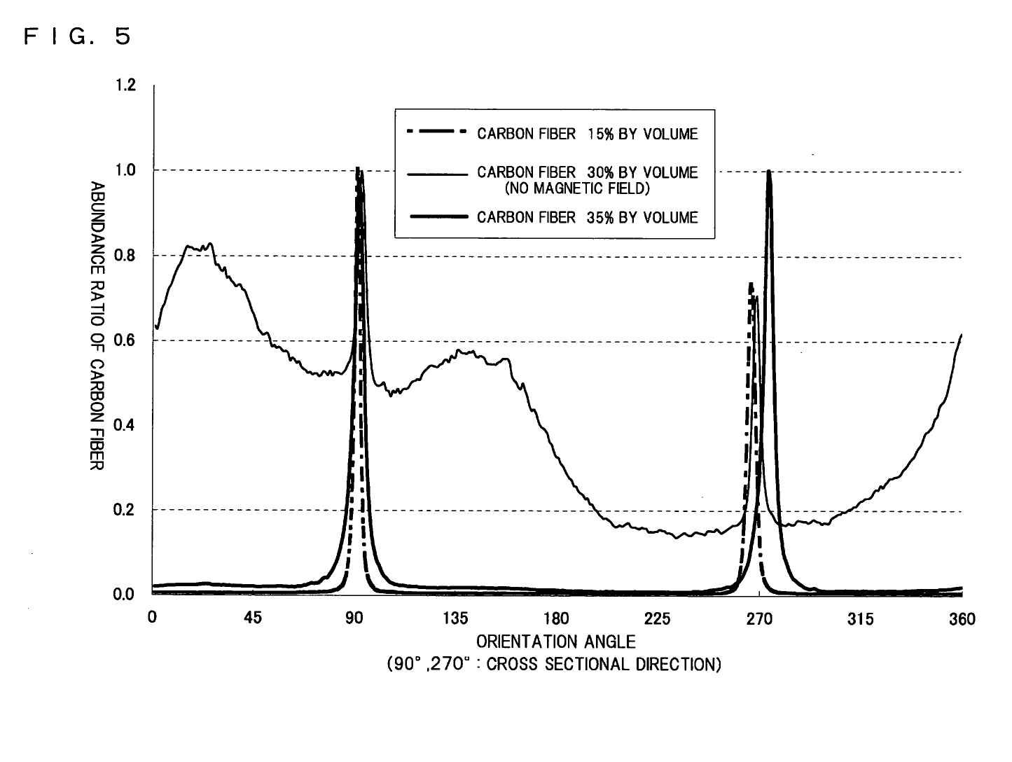

The azimuth intensity distribution on the surface of the graphite crystals (0. 0. 2) of the carbon fiber was measured in the manner described above, i.e. through X-ray diffraction analysis using an X-ray diffraction analysis device, in relation to the 30% by volume compound example, to which the magnetic field was not applied, and the 15% by volume compound example and 35% by volume compound example, to which the magnetic field was applied. The measurement results are shown in FIG. 5. In the 15% by volume compound example and 35% by volume compound example to which the magnetic field was applied, the carbon fiber was oriented favorably in the thickness direction of the test piece 24, and a peak occurred in the azimuth intensity distribution. Having measured the full width at half maximum and determined the degree of orientation using Formula 1 described above, the 15% by volume compound example and 35% by volume compound example were found to have degrees of orientation of 0.98 and 0.97, respectively.

### 2. Visual Confirmation of Sample using Microscope Observation

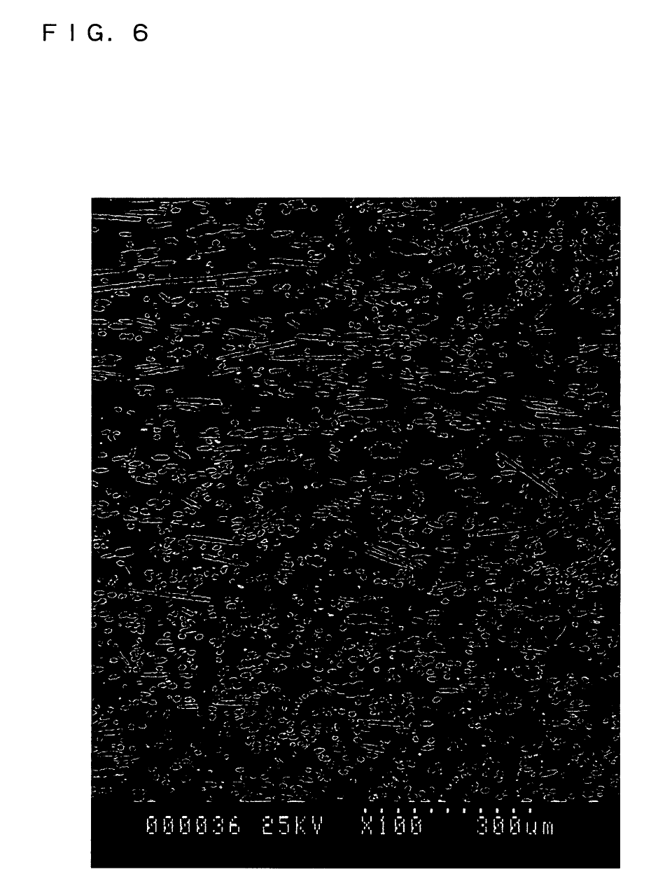

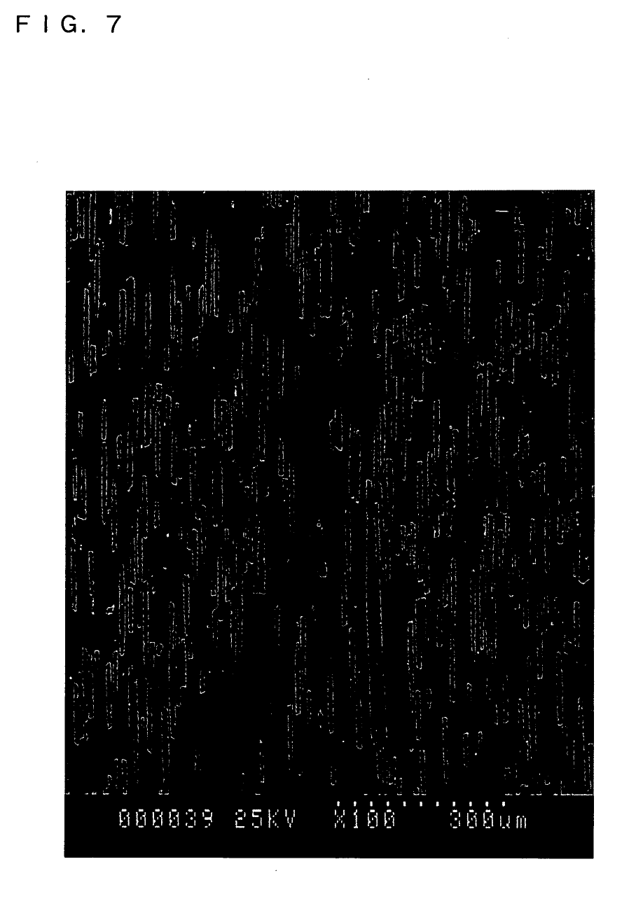

The test pieces of the 25% by volume compound example to which the magnetic field was not applied and the 25% by volume compound example to which the magnetic field was applied were cut in the thickness direction, and the thickness direction orientation of the carbon fiber was observed using a scanning electron microscope. The resulting microphotographs are shown in FIGS. 6 and 7. The dark gray-colored portions denote the polyethylene resin, and the light gray-colored portions denote the carbon fibers. FIG. 6 shows the example to which the magnetic field was not applied, and in this example, the carbon fiber directions are random. FIG. 7 shows the example to which the magnetic field was applied, and in this example, the carbon fiber is oriented regularly in the thickness direction. In other words, the orientation may be considered favorable.

### [Examples in which Carbon Fiber is Oriented]

Having confirmed that the carbon fiber can be oriented favorably in the preliminary test, examples 3a, 4a, 5a, 6a, 7a, 8a, 9a, and 10a and comparative examples 9a and 10a were implemented using fillers having the same material compositions and molding methods as examples 3, 4, 5, 6, 7, 8, 9, and 10, and comparative examples 9 and 10, respectively, but differing therefrom in that the carbon fiber in the base polymeric material (polyethylene resin) was oriented using a magnetic field. Orientation using a magnetic field was performed in a similar manner to the preliminary test described above, using the devices and procedures illustrated in FIGS. 3 and 4. The physical property tests described above were then applied to the test pieces extracted from the space 22 in the device 21. The results are shown in Table 6 and Table 7.

TABLE 6

| | | | Comparative | | | | | | |
|---|---|---|---|---|---|---|---|---|---|
| Composition/Evaluation item | | | Example 9a | Example 3a | Example 4a | Example 5a | Example 6a | Example 7a | Example 8a |
| Composition | Polyethylene resin | | 75 | 75 | 75 | 75 | 75 | 75 | 75 |
| (% by | Filler | PAN-based carbon fiber 1 | — | 25 | — | — | — | — | — |
| volume) | type | PAN-based carbon fiber 2 | — | — | 25 | — | — | — | — |
| | | PAN-based carbon fiber 3 | — | — | — | 25 | — | — | — |
| | | PAN-based carbon fiber 4 | — | — | — | — | 25 | — | — |
| | | PAN-based carbon fiber 5 | — | — | — | — | — | 25 | — |
| | | PAN-based carbon fiber 6 | — | — | — | — | — | — | 25 |
| | | PAN-based carbon fiber | 25 | — | — | — | — | — | — |
| | | (no graft) | | | | | | | |

| | | | | | | | |
|---|---|---|---|---|---|---|---|
| Thermal conductivity (W/mk) | 1.4 | 0.5 | 0.5 | 0.4 | 0.6 | 0.4 | 0.4 |
| Volume specific resistance (Ω · cm) | 1.0 × 10⁵ | 2.0 × 10⁹ | 2.0 × 10⁹ | 8.0 × 10¹² | 2.0 × 10⁶ | 4.0 × 10⁵ | 6.0 × 10⁷ |

TABLE 7

| | | | Comparative | | |
|---|---|---|---|---|---|
| Composition/Evaluation item | | | Example 10a | Example 9a | Example 10a |
| Composition | Polyethylene resin | | 75 | 75 | 75 |
| (% by volume) | Filler | Pitch-based carbon fiber 1 | — | 25 | — |
| | type | Pitch-based carbon fiber 2 | — | — | 25 |
| | | Pitch-based carbon fiber | 25 | — | — |
| | | (no graft) | | | |

| | | | |
|---|---|---|---|
| Thermal conductivity (W/mk) | 13.0 | 12.2 | 8.4 |
| Volume specific resistance (Ω · cm) | 2.7 × 10⁻² | 4.2 × 10⁸ | 1.0 × 10⁶ |

### [Evaluation of Physical Properties]

### D) Evaluation of Examples 3a to 8a using PAN-Based Carbon Fiber

In comparative example 9a (Table 6), in which the PAN-based carbon fiber was oriented, the thermal conductivity is higher than that of comparative example 9 (Table 4), in which the PAN-based carbon fiber was not oriented, and therefore comparative example 9a can be evaluated favorably on this point. However, the electric conductivity is still too high to satisfy requirements.

Meanwhile, in examples 3a to 8a (Table 6), in which the PAN-based carbon fiber was oriented, the thermal conductivity is higher in most cases than that of examples 3 to 8 (Table 4), in which the PAN-based carbon fiber was not oriented, and although the electric conductivity increased, it remained within the required range. Hence, orienting the PAN-based carbon fiber is (i) suitable for a case in which a higher thermal conductivity is required, and (ii) enables a reduction in the PAN-based carbon fiber compounding amount when the same thermal conductivity is sufficient.

### E) Evaluation of Examples 9a, 10a using Pitch-Based Carbon Fiber

In comparative example 10a (Table 7), in which the pitch-based carbon fiber was oriented, the thermal conductivity is far higher than that of comparative example 10 (Table 5), in which the pitch-based carbon fiber was not oriented, and therefore comparative example 10a can be evaluated favorably on this point. However, the electric conductivity increased even further from a level at which it was already too high to satisfy requirements.

Meanwhile, in examples 9a and 10a (Table 7), in which the pitch-based carbon fiber was oriented, the thermal conductivity is far higher than that of examples 9 and 10 (Table 5), in which the pitch-based carbon fiber was not oriented, and although the electric conductivity increased, it remained within the required range. Hence, orienting the pitch-based carbon fiber is (i) suitable for a case in which a higher thermal conductivity is required, and (ii) enables a reduction in the pitch-based carbon fiber compounding amount when the same thermal conductivity is sufficient.

The present invention is not limited to the examples described above, and may be modified appropriately for implementation within a scope that does not depart from the spirit of the invention.

What is claimed is:

1. A low electric conductivity, high heat radiation polymeric composition comprising:
a polymeric material; and
a carbon-based filler compounded with the polymeric material,
wherein the carbon-based filler has an electron withdrawing agent grafted onto a surface of the carbon-based filler.

2. The low electric conductivity, high heat radiation polymeric composition according to claim 1, wherein a graft ratio of the electron withdrawing agent is 0.5% by weight or more.

3. The low electric conductivity, high heat radiation polymeric composition according to claim 2, wherein the carbon-based filler is carbon black, and the graft ratio of the electron withdrawing agent is 20% by weight or more.

4. The low electric conductivity, high heat radiation polymeric composition according to claim 2, wherein the carbon-based filler is PAN-based carbon fiber, and the graft ratio of the electron withdrawing agent is 10% by weight or more.

5. The low electric conductivity, high heat radiation polymeric composition according to claim 2, wherein the carbon-based filler is pitch-based carbon fiber.

6. The low electric conductivity, high heat radiation polymeric composition according to claim 1, wherein an amount of the carbon-based filler compounded with the polymeric material is from 10 to 80% by volume.

7. A low electric conductivity, high heat radiation molded body using the low electric conductivity, high heat radiation polymeric composition according to claim 1.

8. The low electric conductivity, high heat radiation molded body according to claim 7, wherein the carbon-based filler is oriented within the polymeric material.

9. A method of manufacturing a low electric conductivity, high heat radiation molded body, comprising:
molding at least one of a molded body and a molded body serving as a material of the molded body by using the low electric conductivity, high heat radiation polymeric composition according to claim 1; and
orienting a carbon-based filler in a polymeric material of the molded body by using a magnetic field when the polymeric material is in a molten state.
